(19) United States
(12) Patent Application Publication
(10) Pub. No.: US 2026/0085134 A1
(43) Pub. Date: Mar. 26, 2026

(54) METHOD FOR PRODUCING DRY NANOCELLULOSE USING RADICAL REACTION

(71) Applicant: WEARCOM INC., Hanam-si (KR)

(72) Inventors: KYOUNG WOO KIM, Seoul (KR); SANGHON KIM, Daegu (KR); SOONTAE KWON, Seoul (KR)

(21) Appl. No.: 19/339,285

(22) Filed: Sep. 24, 2025

(30) Foreign Application Priority Data
Sep. 26, 2024 (KR) 10-2024-0130730
Aug. 13, 2025 (KR) 10-2025-0112123

(51) Int. Cl. C08B 3/08; B29C 48/00; B29C 48/36; B29C 48/40; B29K 1/00

(52) U.S. Cl. CPC C08B 3/08; B29C 48/022; B29C 48/36; B29C 48/40; B29K 2001/08

(57) ABSTRACT

Disclosed is a cellulose derivative with improved productivity, which includes cellulose; and a fatty acid ester bonded as a side chain to the cellulose by a branching reaction. The branching reaction is performed through a radical reaction using an initiator and a catalyst. Also disclosed is a method for producing dry nanocellulose, which includes mixing cellulose with a reaction composition including a radical initiator, a catalyst, and a reaction medium; and plasticizing the cellulose mixture by stirring and heating.

### BACKGROUND

### 1. Technical Field

The present disclosure relates to a cellulose derivative with improved productivity in which a fatty acid ester is bonded as a side chain and a method for producing dry nanocellulose using a radical reaction. More specifically, a cellulose derivative obtained by bonding a fatty acid ester as a side chain to the hydroxyl group of cellulose may have improved productivity, and thus may be suitable for mass production and have excellent economic efficiency. Furthermore, the present disclosure relates to a cellulose derivative with improved productivity in which a fatty acid ester having has the advantages of being excellent in environment friendliness, causing no environmental pollution during the production process, being harmless to the human body, and being highly safe is bonded as a side chain, and a method for producing nanocellulose based on a dry process by plasticizing cellulose using a radical initiator, a catalyst, and a reaction medium.

### 2. Related Art

Petrochemical plastics release hazardous chemicals during their production and use. They do not degrade naturally, transforming into microplastics, polluting the ecosystem and harming marine life and human health. To address these issues, active research is underway to replace petrochemical plastics with natural polymers. Among natural polymers, cellulose-based polymers (cellulose, alginate, chitosan, hyaluronic acid, etc.) are the most abundant natural polymers on earth, have properties such as high strength, biodegradability, and thermal stability, and are evaluated as very promising alternative resources as high value-added industrial materials. In particular, cellulose is a natural polymer that is found abundantly in nature and recyclable and highly biodegradable, and may be usefully utilized in various industrial fields.

However, natural cellulose is difficult to thermoform and process due to the high rigidity of its molecular chains and the strong hydrogen bonds within and between chains, and thus the control of its properties is limited. Therefore, the development of technologies that can impart plasticizing properties to cellulose-based materials and control their meltability, strength, flexibility, and elasticity is essential, and this is being discussed as a crucial task for the development and application of next-generation cellulose-based materials.

Previously, attempts were made to improve these properties by nanofibrillation of cellulose, primarily through physical crushing. However, this method had disadvantages in that it was time-consuming and energy-intensive, and required the use of large quantities of water. To solve these disadvantages, a chemical nanofibrillation method was introduced, but the harmfulness of the chemicals used caused problems such as being harmful to the human body and causing environmental pollution.

In addition, nanocellulose products produced through this process are generally provided in the form of a suspension, which limits their application, and have problems of low productivity and high production costs, which reduce their economic feasibility.

In order to solve the above problems, there is a need for research on a cellulose production technology that can enhance plasticity and increase productivity by nanofibrillation and/or modification of cellulose in an environmentally friendly manner.

Meanwhile, with the growing demand for environmental protection and sustainable industrial development, the development of biodegradable, bio-based polymer materials that can replace petrochemical plastics is actively underway. Among these materials, cellulose, the most abundant natural polymer in nature, is attracting attention as a next-generation, eco-friendly material due to its excellent biodegradability and mechanical strength.

Cellulose is the most important natural polymer, and its unique properties make it a highly useful material. In particular, nanocellulose is expected to open up new, highly sustainable functionalities. Nanocellulose with nano-sized diameter and length exhibits enhanced interactions with water, organic and polymeric substances, nanoparticles, and living cells due to its increased surface area.

In particular, nanocellulose fibers are strongly crystallized through hydrogen bonds, and thus they have a strength five times that of iron metal and a coefficient of thermal expansion equal to 1/10 or less of that of glass fibers. They account for 50% or more of plant resources such as wood, and thus they can be said to be an infinitely sustainable resource.

However, cellulose has a problem in that it has low thermoplasticity and is difficult to melt-process due to its rigid linear structure composed of β (1→4) glucosidic linkages and strong hydrogen bonds between chains. In addition, its industrial use is difficult due to its high production cost and handling difficulties. To overcome this problem, active research is being conducted in various countries around the world.

These structural characteristics pose a significant obstacle to ensuring processability and flexibility in various industrial applications.

Therefore, in order to utilize cellulose as a high-performance material, the development of technology for physical and chemical modification that can control the properties has been required. Accordingly, research has been conducted to maximize the properties of cellulose by producing cellulose in the form of nanofibrils or nanocrystals. Representative methods include mechanical crushing, TEMPO oxidation that mainly oxidizes —OH at the C6 position in cellulose nanofibrillation, phosphoric acid esterification, acid hydrolysis, and ionic liquid treatment, but these have the following limitations in terms of mechanical and chemical treatment, respectively.

Mechanical crushing processes, such as those using high-pressure dispersers, ball mills, and grinders, have problems such as high energy consumption, small processing volume, and time consumption, and chemical treatment methods, such as TEMPO oxidation, phosphoric acid esterification, and acid hydrolysis, use hazardous chemicals, which are harmful to the human body and the environment, and have side effects such as water treatment burden and equipment corrosion.

In addition, since nanocellulose is mostly produced in a suspension form in an aqueous wet process rather than a dry process, there are problems with processability and transportability due to lack of compatibility with the dry process, and there is also a problem of technical difficulty in solid content concentration.

For this reason, there is a need for a cellulose modification technology that can simultaneously ensure nanofibrillation and plasticization characteristics while being based on a dry process.

Recently, cellulose modification technology utilizing radical reactions has been attracting attention. Radical reactions allow radical species activated under the action of an initiator and a catalyst to act on the reactive sites of cellulose, thereby introducing new functional groups or rearranging the polymer structure.

In particular, a technology has been proposed to impart plasticity by bonding fatty acid esters as side chains to the hydroxyl groups (—OH) of cellulose. However, complete nanofibrillation of cellulose molecules is difficult, which limits the production of high value-added materials. In addition, it is a process that is unsuitable for process shortening and mass production due to its dependence on an aqueous system or long reaction time, and problems arise in that technical difficulties are involved in ensuring product quality and consistency depending on the mixing, stirring, dispersion, and reaction optimization conditions.

Therefore, there is a need for the development of a new process technology capable of efficient nanofibrillation and plasticization of cellulose based on a dry process while maximizing the advantages of radical reactions.

This technology can become a basic technology that can overcome the shortcomings of existing high-energy crushing methods or nanofibrillation methods based on hazardous chemicals and can convert cellulose into functional nano-materials in a short time under low-energy and environmentally friendly conditions.

In order to solve the above problems, research is needed on a technology capable of producing dry nanocellulose using a radical reaction.

### SUMMARY

The present disclosure has been made in order to solve the above-described problems occurring in the prior art, and is intended to provide a cellulose derivative obtained by bonding a fatty acid ester as a side chain to the hydroxyl group of cellulose, which has improved productivity, and thus is suitable for mass production and has excellent economic efficiency. In addition, the present disclosure is intended to provide a technical content for a cellulose derivative with improved productivity in which a fatty acid ester having has the advantages of being excellent in environmental friendliness, causing no environmental pollution during the production process, being harmless to the human body, and being highly safe is bonded as a side chain.

In addition, the present disclosure is intended to provide a technical content for a method for producing nanocellulose, which is excellent in environmental friendliness, reduces energy consumption, and improves productivity, by producing nanocellulose in a dry manner by plasticizing cellulose through a radical reaction of cellulose using a radical initiator, a catalyst, and a reaction medium.

The present disclosure relates to a cellulose derivative with improved productivity in which a fatty acid ester is bonded as a side chain.

In order to achieve the technical problem as described above, the present disclosure provides a cellulose derivative with improved productivity, including: cellulose; and a fatty acid ester bonded as a side chain to the cellulose by a branching reaction, wherein the branching reaction is performed through a radical reaction using an initiator and a catalyst.

The present disclosure also provides a method for producing dry nanocellulose, including steps of: mixing cellulose with a reaction composition including a radical initiator, a catalyst, and a reaction medium; and plasticizing the cellulose mixture by stirring and heating.

According to a preferred embodiment of the present disclosure, the branching reaction may be performed using, based on 100 parts by weight of the cellulose, 1 to 50 parts by weight of the fatty acid ester, 0.01 to 10 parts by weight of the initiator, and 0.01 to 10 parts by weight of the catalyst.

In addition, according to a preferred embodiment of the present disclosure, the fatty acid ester may be glycerol monostearate.

In addition, according to a preferred embodiment of the present disclosure, the initiator may include any one or more selected from among peroxides and azo compounds.

In addition, according to a preferred embodiment of the present disclosure, the branching reaction may be performed at a temperature of 50 to 300° C.

In addition, according to a preferred embodiment of the present disclosure, in the branching reaction, the fatty acid ester is bonded to the oxygen of the C6 hydroxyl group of the cellulose instead of hydrogen.

The present disclosure relates to a method for producing nanocellulose using a radical reaction.

In order to achieve the technical problem as described above, the present disclosure provides a method for producing dry nanocellulose, including steps of: mixing cellulose with a reaction composition including a radical initiator, a catalyst, and a reaction medium; and plasticizing the cellulose mixture by stirring and heating.

In addition, according to a preferred embodiment of the present disclosure, the reaction composition may further include any one or more auxiliary agents selected from among a silane coupling agent and a nonionic surfactant.

In addition, according to a preferred embodiment of the present disclosure, the radical initiator may include any one or more selected from among organic peroxide-based, hydroperoxide-based, and hydrogen peroxide-based compounds.

In addition, according to a preferred embodiment of the present disclosure, the catalyst may include any one or more selected from among iron ions (Fe²⁺), cobalt ions (Co²⁺), manganese ions (Mn²⁺), copper ions (Cu⁺), and copper ions (Cu²⁺).

In addition, according to a preferred embodiment of the present disclosure, the reaction medium may include any one or more selected from among polyethylene glycol 400 (PEG400), dimethyl sulfoxide (DMSO), ethanol (EtOH), stearic acid, wax, ethylene, a glycerol oligomer, and lactide ionic liquid.

In addition, according to a preferred embodiment of the present disclosure, the method may further include, after the step of plasticizing, a step of extruding the plasticized cellulose mixture through a reactive extruder.

The cellulose derivative with improved productivity in which a fatty acid ester is bonded as a side chain according to the present disclosure includes a fatty acid ester bonded as a side chain to the hydroxyl group of cellulose, and thus may have improved productivity, be suitable for mass production and have excellent economic efficiency. In addition, the fatty acid ester used for the branching may have the advantages of being excellent in environment friendliness, causing no environmental pollution during the production process, being harmless to the human body, and being highly safe.

The method for producing nanocellulose using a radical reaction according to the present disclosure may effectively plasticize and nanofibrillate cellulose under dry conditions by using a radical reaction, thereby achieving excellent energy-saving effects and improving productivity compared to the existing wet treatment method. In addition, it generates no wastewater and may minimize the use of chemicals, thereby preventing environmental pollution and realizing an eco-friendly process.

In addition, the efficiency of radical initiation and the uniformity of the plasticization reaction may be improved through a radical initiator, a catalyst, a reaction medium, and an auxiliary agent, and the stability of the reaction may be improved, thereby ensuring the compatibility and mechanical properties of the produced nanocellulose, thus increasing the usability of the cellulose.

### BRIEF DESCRIPTION OF THE DRAWINGS

FIG. 1 shows the molecular structural formula of cellulose with improved productivity obtained by bonding glycerol monostearate as a side chain to cellulose C6 according to one embodiment of the present disclosure.

FIG. 2 shows the molecular structural formula of cellulose with improved productivity obtained by bonding glycerol monostearate as a side chain to cellulose C2 and C6 according to one embodiment of the present disclosure.

FIG. 3 is a molecular diagram showing the principle by which a reaction medium according to one embodiment of the present disclosure increases the physical distance between cellulose molecules so that radicals may penetrate between them.

FIG. 4 is a molecular diagram showing a radical reaction mechanism of cellulose according to one embodiment of the present disclosure.

### DETAILED DESCRIPTION

Hereinafter, a cellulose derivative with improved productivity in which a fatty acid ester is bonded as a side chain according to the present disclosure, and a method for producing dry nanocellulose using a radical reaction according to the present disclosure will be described using specific examples. However, the following embodiments are provided so that this disclosure will fully convey the spirit of the present disclosure to those skilled in the art.

Therefore, the present disclosure is not limited to the embodiments presented below and may be embodied in other forms. The embodiments presented below are described only to clarify the idea of the present disclosure, and the present disclosure is not limited thereto.

Unless otherwise defined, all terms used herein, including technical and scientific terms, have the same meaning as commonly understood by one of ordinary skill in the art to which the present disclosure pertains. The terms are terms defined in consideration of their functions in the present disclosure and may change depending on the intents of a user or an operator, or depending on precedents. Accordingly, these terms should be defined based on the entire contents of the present disclosure. In the following description, the description of known functions and configurations will be omitted when it may obscure the subject matter of the present disclosure.

In addition, the singular forms used in the specification and the attached claims are intended to include the plural forms as well, unless the context clearly dictates otherwise.

In addition, the thickness of lines and the size of constituent elements shown in the drawings may be exaggerated for clarity and convenience of explanation.

Hereinafter, the present disclosure will be described in detail.

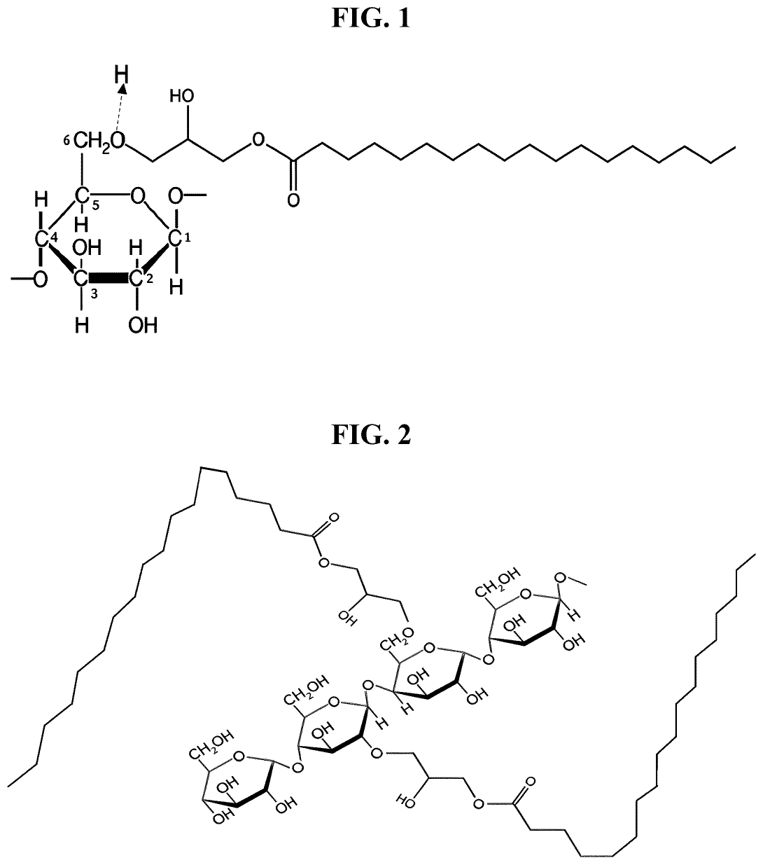

FIG. 1 shows the molecular structural formula of cellulose with improved productivity obtained by bonding glycerol monostearate as a side chain to cellulose C6 according to one embodiment of the present disclosure.

FIG. 2 shows the molecular structural formula of cellulose with improved productivity obtained by bonding glycerol monostearate as a side chain to cellulose C2 and C6 according to one embodiment of the present disclosure.

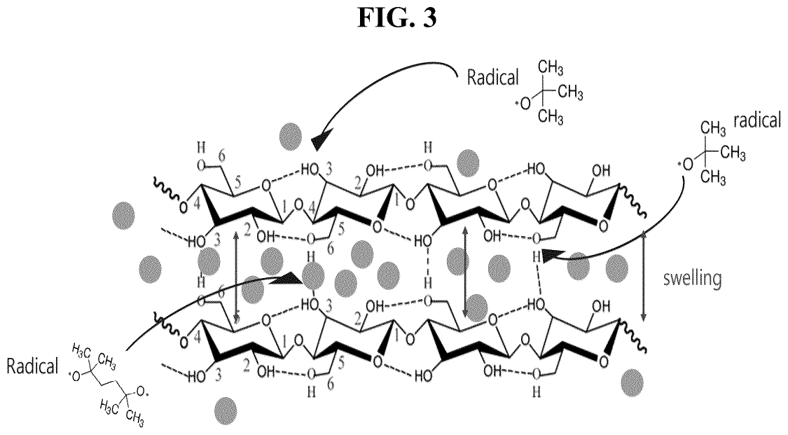

FIG. 3 is a molecular diagram showing the principle by which a reaction medium according to one embodiment of the present disclosure increases the physical distance between cellulose molecules so that radicals may penetrate between them.

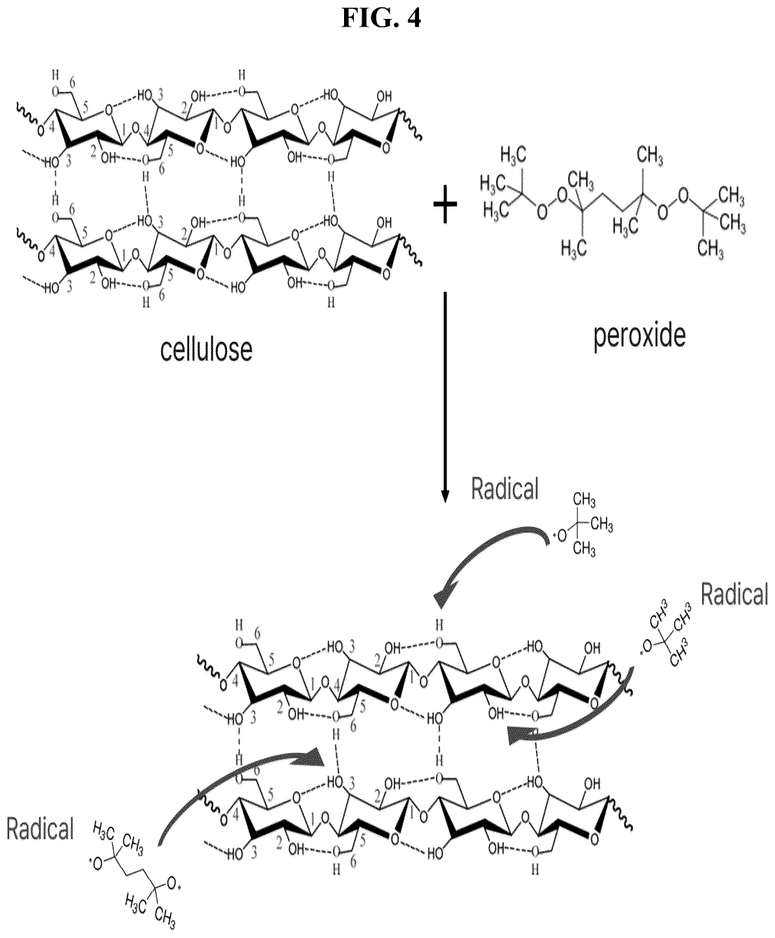

FIG. 4 is a molecular diagram showing a radical reaction mechanism of cellulose according to one embodiment of the present disclosure.

Referring to FIG. 1, the present disclosure provides a cellulose derivative with improved productivity, including: cellulose; and a fatty acid ester bonded as a side chain to the cellulose by a branching reaction, wherein the branching reaction is performed through a radical reaction using an initiator and a catalyst.

The cellulose of the present disclosure is a natural polymer that is found abundantly in nature and is recyclable and highly biodegradable. The cellulose is attracting attention as a promising material that may replace petrochemical plastics. Cellulose is a natural polymer found in the cell walls of plants, and may be extracted through mechanical or chemical treatment, and its chemical formula is (C₆H₁₀O₅)n. This polysaccharide is composed of hundreds to thousands of D-glucose units linked by β(1→4) bonds to form linear chains. It has a very stable structure through intramolecular hydrogen bonds, and thus exhibits excellent durability.

However, cellulose is difficult to thermoform and process due to the high rigidity of its molecular chains and the strong hydrogen bonds within and between chains, and thus the control of its properties as a material to replace petrochemical plastics may be limited. To overcome these limitations, methods to impart plasticity to cellulose may be used to weaken or eliminate the hydrogen bonds within the molecule.

In the present disclosure, in order to weaken or eliminate hydrogen bonds within the cellulose molecules, the branching method may be used to chemically bond new side chains to the positions where intermolecular hydrogen bonds of the cellulose polymer occur.

The branching method of the present disclosure may be a chemical modification method that binds one or more new fatty acids or a compound containing an alkyl group having flexibility by including two or more methylene groups to the main chain cellulose, and may have the advantage of adding desired properties without changing the structure of the existing polymer.

In the present disclosure, the main chain may be cellulose, and the compound bonded as a side chain may be a fatty acid ester, without being limited thereto. The compound bonded as a side chain may provide an effect of enhancing the plasticity of the cellulose by combining with the cellulose hydroxyl group to weaken or eliminate intramolecular hydrogen bonds.

Fatty acid ester, which is used as a compound bonded as a side chain to the cellulose, is a compound formed by ester bonding between a fatty acid and an alcohol. It is a compound that is widely found in nature and highly safe. Specifically, it may be utilized in various applications, such as foods, cosmetics, pharmaceuticals, industrial lubricants, and nonionic surfactants.

The fatty acid ester contains a large number of methylene groups, and thus may exhibit properties that allow it to adapt to external energy and move smoothly. Due to these properties, when the fatty acid is bonded as a side chain to cellulose, it may exhibit excellent plasticity.

The fatty acid ester may include any one or more selected from among methyl palmitate, ethyl palmitate, propyl palmitate, octyl palmitate, butyl stearate, isopropyl myristate, methyl stearate, glyceryl stearate, glyceryl palmitate, glyceryl oleate, glyceryl laurate, sorbitan stearate, and xylitol palmitate, without being limited thereto.

More preferably, the fatty acid ester may include any one or more selected from among glyceryl stearate, glyceryl palmitate, glyceryl oleate, glyceryl laurate, sorbitan stearate, and xylitol palmitate. By including such fatty acid esters, the efficiency of the radical generation reaction may be improved. General fatty acid esters are mainly composed of stable saturated bonds, and thus radical generation may not occur easily. However, fatty acid esters such as glyceryl stearate, glyceryl palmitate, glyceryl oleate, glyceryl laurate, sorbitan stearate, and xylitol palmitate are formed by combining fatty acids and polyols, and contain more hydroxyl groups, and thus radical generation may occur relatively easily.

Most preferably, the fatty acid ester may be glyceryl stearate. The glyceryl stearate has a structure in which glycerol and one stearic acid are ester-bonded, and may be identical to glycerol monostearate. Therefore, the fatty acid ester may be glycerol monostearate.

The glycerol monostearate of the present disclosure is a natural ingredient derived from palm fruit and soybean oil, and is an environmentally friendly substance that may be widely used in cosmetics and personal care products. This substance does not cause environmental pollution during the production process and is safe to handle, thus exhibiting excellent environmental friendliness.

In addition, since the glycerol monostearate contains a polyhydric alcohol structure, it may have a higher radical formation efficiency than when using methyl stearate or stearic acid, which have a similar structure. This can provide an effect of further enhancing the plasticity of the main chain cellulose.

The initiator of the present disclosure serves to generate free radicals necessary to initiate a reaction. Generally, radical reactions are reactions with high activation energy, and radicals must first be formed for the reaction to begin. The initiator for initiating such radical reactions may be a substance that readily decomposes under appropriate conditions, such as heat, light, or a chemical reaction, to generate radicals.

The initiator of the present disclosure may serve to promote a branching reaction between cellulose and glycerol monostearate and initiate the reaction by generating radicals.

The initiator of the present disclosure may include any one or more selected from among peroxides and azo compounds.

The peroxides are compounds containing a peroxide group, which are easily decomposed in the presence of heat, light, or other catalysts to generate free radicals. Examples thereof include benzoyl peroxide, acetyl peroxide, dilauryl peroxide, and di-tert-butyl peroxide.

In addition, the azo compounds can generate radicals while releasing nitrogen molecules by thermal decomposition. Specifically, examples thereof include azobisisobutyronitrile (AIBN), azobiscyclohexanenitrile, etc.

In addition, the catalyst of the present disclosure may serve to promote the reaction with glycerol monostearate by increasing the efficiency of generation of radicals from the initiator. The catalyst may include any one or more selected from among dimethylamine, triethylamine, N, N-dimethyl-p-toluidine, N-hydroxyphthalimide (NHPI), cobalt (II) acetate, cobalt (II) chloride, cuprous (I) chloride, cuprous (I) bromide, tin (II) 2-ethylhexanoate, peracetic acid, and m-chloroperbenzoic acid.

Most preferably, the catalyst may include tin (II) octoate (tin (II) 2-ethylhexanoate). The tin (II) octoate is in the form of a tin (II) ion bonded to two octanoic acid molecules, has a molecular formula of C₁₆H₃₀O₄Sn, and may be a transparent or light yellow liquid. This catalyst is widely used in radical polymerization reactions, and may serve to improve performance and durability in the synthesis of polyester and polyurethane, the production of thermosetting resins, the curing of coatings and paints, the production of adhesives, and the processing of leather.

When the tin (II) octoate is used as a catalyst, the radical generation efficiency is the highest, so that the branching reaction proceeds smoothly, and the tin (II) octoate may have excellent environmental friendliness. The tin (II) octoate not only has the effect of promoting the branching reaction by increasing the radical generation efficiency in the radical polymerization reaction, but also has the characteristic of being environmentally friendly because it has lower toxicity compared to other organometallic catalysts. Thus, the tin (II) octoate causes no environmental pollution during the production process and may provide the advantage of excellent overall environmental friendliness.

In addition, in the branching reaction, the fatty acid ester may be bonded to the oxygen of at least one selected from among the C2, C3, and C6 hydroxyl groups of the cellulose instead of hydrogen. More specifically, in the branching reaction, glycerol monostearate may be bonded to the oxygen of the C6 hydroxyl group of the cellulose instead of hydrogen. The C6 of the cellulose refers to carbon 6 of cellulose, exists in the form of a hydroxymethyl group (—CH₂OH), and may have excellent spatial accessibility as it is located at the end of the molecule. In addition, the hydrogen attached to the oxygen of the hydroxyl group on C6 of cellulose may be a relatively weak bond that may be most easily dissociated by external energy among the bonds that constitute cellulose. Therefore, when the fatty acid ester is bonded as a side chain to the cellulose main chain, the reactivity at this position may be the highest. Therefore, the reaction rate may be relatively fast, and productivity may be improved.

In addition, when the glycerol monostearate binds to the oxygen of the C6 hydroxyl group of cellulose, the strength of the intramolecular hydrogen bond may be reduced, so that the rigidity of the molecular chain may be lowered and plasticity may be enhanced. The glycerol monostearate that plasticizes the cellulose contains a long chain structure, so that it may easily react when external energy is applied. When external energy is applied, the glycerol monostearate undergoes vibrational and stretching motion, and thus cellulose molecules may soften from a state where they were unable to move due to intramolecular hydrogen bonds, thereby providing the effect of enhancing plasticity.

Additionally, the glycerol monostearate residue that does not participate in the branching reaction and remains may act as a plasticizer between cellulose molecules, allowing the cellulose to move easily by external energy. This can further enhance plasticity. The residue has excellent environmental friendliness and does not constitute a hazardous substance. Furthermore, due to the hydrophilic group at one end and the hydrophobic group at the other end, the residue may act as an emulsifier and provide relatively high stability when formulated as a suspension formulation.

In addition, the branching reaction may be performed using, based on 100 parts by weight of the cellulose, 1 to 50 parts by weight of the fatty acid ester, 0.01 to 10 parts by weight of the initiator, and 0.01 to 10 parts by weight of the catalyst. Through the branching reaction using the above components and content ranges (parts by weight), the efficiency and selectivity of the radical reaction applied to the branching reaction may be maximized and the production of unwanted byproducts may be minimized. This can improve the quality and performance of the final product.

However, if the contents of the components are out of the above ranges, a large amount of unwanted byproducts may be generated due to side reactions. Such side reactions may include, for example, chain scissoring by radicals. The chain scissoring reaction may cleave the cellulose polymer chains, thereby reducing the molecular weight and making the cellulose structure uncertain. Additionally, transesterification may occur between the hydroxyl groups of the cellulose and the ester groups of the glycerol monostearate, which may result in the production of unwanted byproducts.

In addition, if the initiator or the catalyst is used in an amount smaller than the lower limit of the above range, the initiation of radical reaction may not occur, and if the initiator or the catalyst is used in an amount larger than the upper limit of the above range, byproducts may increase due to molecular degradation or cross-linking. This may result in excessive hardness, and increased chemical resistance, making it difficult to dissolve in solvents.

In addition, most preferably, the initiator may include benzoyl peroxide. Benzoyl peroxide may act stably at high temperatures and may generally decompose at 75 to 80° C., efficiently generating radicals. In addition, since the rate of radical generation may be controlled depending on the temperature, benzoyl peroxide may be useful in adjusting the desired reaction rate and conditions. In addition, benzoyl peroxide may have the effect of improving the selectivity and yield of the reaction by producing fewer impurities.

In addition, the branching reaction may be performed at a temperature of 50 to 300° C. When the temperature of the branching reaction is 50 to 300° C., the reactivity may be the highest, productivity may be improved, the amount of unwanted by-products produced may be small, and the quality may be excellent.

More preferably, the temperature of the branching reaction may be 70 to 250° C. If the temperature of the branching reaction is lower than 70° C., the radical generation efficiency may decrease, resulting in the formation of fatty acid ester radicals, so that the reaction may not be initiated. If the temperature is higher than 250° C., the cross-linking between polymer chains may increase, so that the polymer may be excessively hardened and become hard, it becomes difficult to control physical properties, and solubility and plasticity may be reduced, which may reduce processability. In addition, the radical reaction rate may excessively increase, so that abnormal interactions between polymer chains may occur, which may result in a decrease in the selectivity of the reaction site, non-uniform branching, and a decrease in quality due to the generation of unwanted by-products.

In addition, phase separation between the cellulose and the fatty acid ester may occur in the branching reaction. More specifically, phase separation between the cellulose and the glycerol monostearate may occur at a temperature of 68° C. or higher in the branching reaction as the glycerol monostearate is liquefied.

If phase separation occurs between the two substances, it may be difficult to uniformly mix the reactants and the quality of the cellulose derivative produced may be reduced. To solve this problem, the stirring speed of the cellulose/fatty acid ester mixture may be set to 300 to 600 rpm to enable more uniform mixing. If the stirring speed is less than 300 rpm, phase separation of the cellulose/fatty acid ester mixture may occur, and if the stirring speed is more than 600 rpm, it may cause excessive fluidization and lead to unnecessary energy consumption.

In addition, the branching reaction may include a process of sonicating a mixture of the cellulose and the fatty acid ester. The sonication process may have the effect of producing a high-quality cellulose derivative by more uniformly mixing the cellulose/fatty acid ester mixture, which may undergo phase separation.

The sonication may be performed using a low frequency of 20 to 30 kHz. When mass-producing a cellulose derivative by applying a low frequency within the above range, effective dispersion by high output may be achieved, preventing phase separation and uniformly mixing the cellulose and the fatty acid ester. However, if the sonication is performed at a frequency of less than 20 kHz, the cellulose and fatty acid ester structures may be damaged due to excessively strong energy, which may result in a decrease in the uniformity of the reaction. If the frequency is more than 30 kHz, physical mixing may not be smooth, which may result in phase separation, a longer reaction time, and a decrease in quality and productivity due to a decrease in uniformity.

In addition, the cellulose derivative, which is the branching reaction product of the present disclosure, may be nanocellulose having a fiber diameter of 1 to 100 nm. The cellulose derivative of the present disclosure may have weakened hydrogen bonds within cellulose molecules through the branching reaction, and increased plasticity, or a nano-sized diameter due to disintegration.

In addition, the production of the cellulose derivative may be 900 to 1,500 kg/day. Existing nanocellulose production techniques include mechanical treatment (high-pressure homogenization, microfluidizer method, grinder method, ball mill crushing method, bead mill crushing method, freeze crushing method, and shaft kneading method), chemical treatment (TEMPO oxidation method, phosphoric acid esterification method, carboxyl methylation method, sulfonation method, oxygen hydrolysis method, and ionic liquid selective dissolution method), biocompatibility (bacteria), etc., and the above-described techniques can exhibit a daily average production of up to about 50 kg. However, as the cellulose derivative of the present disclosure, nanocellulose having a diameter of 100 nm or less may be produced at a production rate of 900 to 1,500 kg/day, which is about 20 times more. The cellulose derivative obtained through the radical branching reaction of the present disclosure may be characterized by excellent productivity in that it has a short reaction time of 1 to 5 hours, does not require additional processes, and thus may be produced at a very fast rate and mass-produced.

In addition, the mechanical treatment method has a disadvantage in that it consumes a lot of energy because it requires repeated physical crushing, and the organic solvent and acid and base reagents used in the chemical treatment method have a problem in that they can cause serious environmental pollution. However, the cellulose derivative with improved productivity according to the present disclosure has a characteristic in that it does not cause environmental pollution because it is produced using relatively environmentally friendly reactants and reagents.

In addition, the cellulose derivative with improved productivity in which the fatty acid ester is bonded as a side chain according to the present disclosure exhibits excellent mechanical properties, biodegradability, excellent plasticity, high specific surface area, etc., and thus may be used as a reinforcement for composite materials such as plastics, metals, and ceramics, and as a reinforcement for building materials such as concrete and cement, and may be used in the manufacture of non-woven fabrics, paper, and packaging materials. In addition, it may be used in the medical and life science fields such as drug delivery systems, tissue engineering scaffolds, and wound healing materials, and may be applied to surface coatings and films due to its improved waterproofing, transparency, and durability properties, and may be used as a viscosity regulator and a stabilizer for cosmetics. In addition, it may be applied as an insulating material for conductive composite materials and electronic devices, and may be used in environmental purification technologies such as adsorption and removal of pollutants and wastewater treatment. In addition, it may be used as a viscosity regulator and a stabilizer for foods to improve food texture and quality. However, the application fields of the cellulose derivative are not limited thereto.

The present disclosure also provides a method for producing dry nanocellulose, including steps of: mixing cellulose with a reaction composition including a radical initiator, a catalyst, and a reaction medium; and plasticizing the cellulose mixture by stirring and heating.

The radical initiator of the present disclosure serves to generate free radicals necessary to initiate a reaction. Generally, a radical reaction is a reaction with high activation energy, and radicals should first be formed for the reaction to begin. The initiator for initiating such a radical reaction may be a substance that is easily decomposed under appropriate conditions such as heat, light, or a chemical reaction to generate radicals

The radical initiator of the present disclosure may serve to help initiate a reaction by generating radicals of cellulose.

According to a preferred embodiment of the present disclosure, the radical initiator is a compound capable of generating radicals at high temperature or in the presence of a catalyst, and may include an organic peroxide-based, hydroperoxide-based, or hydrogen peroxide-based compound.

The organic peroxide-based compound (BPO, DCP, MEKPO, or diacyl peroxide) is mainly used for polymer initiation and acts as a crosslinking agent. The hydroperoxide-based compound exhibits high reactivity and may be a radical generator. The hydrogen peroxide-based compound is water-soluble and may efficiently generate radicals when used in combination with a metal catalyst.

More specifically, the radical initiator may include at least one selected from among benzoyl peroxide (BPO), dicumyl peroxide (DCP), methyl ethyl ketone peroxide (MEKPO), hydroperoxide, diacyl peroxide, and hydrogen peroxide (H₂O₂).

The benzoyl peroxide (BPO) is a representative aromatic organic peroxide, and is widely used in radical polymerization or initiation reactions by generating benzoyl radicals (BzO·) through thermal or catalytic decomposition of the peroxide bond (—O—O—). BPO may be decomposed even at relatively low temperatures to release radicals, and is effective in polymer polymerization, modification, and initiation reactions under non-high temperature conditions. In particular, it has the characteristic of exhibiting stable initiation activity even in radical reactions combined with polymers such as cellulose.

In addition, when BPO is used in combination with methyl ethyl ketone peroxide (MEKPO) or hydroperoxide, synergistic effects such as control of reaction initiation temperature, control of radical generation rate, and improvement of reaction sustainability may occur. For example, when BPO is used in combination with MEKPO, it may maintain reaction stability along with rapid initiation at medium temperature, thereby improving radical initiation efficiency and uniformity of the plasticization reaction.

The dicumyl peroxide (DCP) is an organic peroxide having an asymmetric alkyl substitution structure, exhibits high thermal stability, and is decomposed at high temperatures (130° C. to 180° C.) to generate radicals. For this reason, DCP is widely used as a high-temperature radical initiator or cross-linking agent. In particular, DCP may improve mechanical strength and thermal stability by reacting with carbon-carbon double bonds within a polymer chain to form a cross-linked structure or inducing a radical reaction with a cellulose-based substrate.

The DCP may be used as a two-stage temperature initiation system, particularly when used in combination with BPO or hydroperoxide. For example, BPO may initially initiate the reaction at low temperatures, and then DCP may act in the subsequent high-temperature region, thereby continuously inducing the reaction. This combination is advantageous for ensuring sustained radical supply and controlling the thermal reaction.

The hydroperoxide is a radical-generating precursor having a general structure of ROOH, and acts as a source of organic radicals (R·) and hydroxyl radicals (·OH). In particular, the hydroperoxide is easily decomposed by metal ions or heat to generate radicals, and is widely used in polymer modification, cellulose surface activation, and oxidative modification of organic compounds. Organic hydroperoxides substituted with various alkyl and aryl groups have the advantage of being able to control the selectivity and reactivity of radicals.

The hydroperoxide may be used in combination with MEKPO or H₂O₂ (hydrogen peroxide) to form an isomeric radical system, thereby simultaneously controlling the reaction rate and the radical type. In particular, the mixed initiation system is effective in improving the uniformity of reaction diffusion within a porous material and the efficiency of surface modification.

The methyl ethyl ketone peroxide (MEKPO) is an organic peroxide containing a ketone derivative, and is a highly reactive initiator that may be decomposed even at room temperature or medium temperature (60 to 100° C.) to generate radicals. It exists in a liquid state, which is easy to handle, has excellent dispersibility in a low-viscosity medium, and has the characteristics of being able to rapidly induce a reaction after radical initiation. MEKPO is particularly effective in rapid modification and plasticization reactions of resins cellulose, and polymer derivatives.

MEKPO is generally used in combination with BPO or DCP, and when it is used in combination with BPO, it may exhibit synergy in terms of improving low-temperature initiation rate, and when it is used in combination with DCP, it may exhibit synergy in terms of reaction stability and late radical maintenance. Thereby, it may be used as a two-stage initiation reaction control system.

The diacyl peroxide has a structure in which two acyl groups (R—CO—) are connected through a peroxide bond (—O—O—), and exhibit high reaction selectivity in radical initiation reactions. A representative example thereof is BPO, and various forms of diacyl peroxides substituted with alkyl or aryl acyl groups exist. Upon decomposition, the diacyl peroxide generates acyl radicals (RCO·), which may participate in double bond initiation, dehydrogenation reactions, surface oxidation reactions, etc.

The diacyl peroxide, when used in combination with hydroperoxide or MEKPO, may control multiple reactivities according to the coexistence of different radicals, and thus is suitable for complex reaction systems such as polymer structure control and nanocellulose surface modification.

The hydrogen peroxide (H₂O₂) is an inorganic peroxidizing agent that generates hydroxyl radicals (·OH) upon decomposition, exhibiting very high oxidizing power and reactivity. It is highly soluble in water and, when used together with a metal catalyst (e.g., Fe²⁺, Cu²⁺, etc.), may generate powerful radicals through the Fenton reaction. Due to these properties, hydrogen peroxide (H₂O₂) is widely used in the pretreatment, oxidative modification, decolorization, and surface activation of cellulose or lignin-based materials.

In addition, when H₂O₂ is used together with BPO or hydroperoxide, it may form a system for simultaneous generation of organic radicals and inorganic radicals, and thus may be utilized as a reaction control system for composite materials or a continuous radical generation system.

In addition, the catalyst of the present disclosure may serve to promote a reaction by increasing the efficiency of generation of radicals from the initiator.

The radical initiation reaction that is used in the present disclosure may be more efficiently induced in the presence of a metal ion catalyst along with the decomposition of the radical initiator.

According to a preferred embodiment of the present disclosure, the catalyst may include one or more of iron ions (Fe²⁺), cobalt ions (Co²⁺), manganese ions (Mn²⁺), copper ions (Cu⁺), or copper ions (Cu²⁺), and may contribute to promoting a decomposition reaction of a radical initiator or inducing the generation of active radicals through a redox mechanism such as a Fenton reaction.

The iron ion (Fe²⁺) reacts with hydrogen peroxide (H₂O₂) or organic hydroperoxide to induce the Fenton reaction, enabling the generation of strong hydroxyl radicals (·OH). This is effective in the oxidation modification of polymers and surface activation of cellulose.

The cobalt ion (Co²⁺) promotes radical generation when reacting with organic peroxide or hydroperoxide, and may improve the stability and repeatability of the initiation reaction through a continuous redox cycle (Co²⁺/Co³⁺). It is particularly useful as a stable catalyst in a high-temperature reaction system.

The manganese ion (Mn²⁺) may be converted into various oxidation states (Mn²⁺↔Mn³⁺↔Mn⁴⁺), and may act as a metal catalyst that mediates the generation of various radicals when reacting with peroxides, which may improve the controllability of radical initiation and control the rate of peroxide decomposition.

The copper ion (Cu⁺) or copper (I) ion may generate radicals or reactive oxygen species in the process of being oxidized and converted into copper (II) (Cu²⁺), and may increase radical initiation efficiency, especially when used together with MEKPO or H₂O₂.

The copper ion (Cu²⁺) or copper (II) ion may generates radicals or oxidized metal radicals through a redox reaction when reacting with hydroperoxide or hydrogen peroxide, and may act as a promoter for cellulose structural modification or polymer radical reaction. In addition, it may sustain the catalytic reaction through the cyclic conversion of Cut/Cu²⁺.

In the present disclosure, the metal ion catalysts may be used alone or in combination or two or more. For example, when iron ions (Fe²⁺) and copper ions (Cut or Cu²⁺) are used in combination, they may exhibit a complementary effect of generating active radicals through the Fenton reaction and ensuring reaction sustainability through redox cycles between metals. In addition, the combined use of cobalt ions (Co²⁺) and manganese ions (Mn²⁺) may be useful for more precisely controlling radical generation or adjusting reaction selectivity.

Such combinations of metal ion catalysts may be used to precisely control the reactivity with radical initiators, the rate of radical generation, the reaction temperature range, or the degree of modification of the polymer surface, and the present disclosure may include both modifications and applications of such combinations.

In addition, the reaction medium plays a key role in plasticizing and nanofibrillating cellulose at high temperatures in combination with the radical initiator and the catalyst, and the reaction rate, uniformity, dispersibility, and the physical properties of the product may be controlled depending on the characteristics of the selected medium.

The reaction media may be used alone or in combination of two or more, thereby enabling process optimization and ensuring universality of application.

The reaction medium may improve the reaction accessibility of the radical initiator by partially destroying the hydrogen bond network between cellulose molecules or inducing swelling, and is preferably a non-volatile substance.

According to a preferred embodiment of the present disclosure, the reaction medium is a substance capable of penetrating radicals and ensuring thermal stability, and may include any one or more selected from among polyethylene glycol 400 (PEG400), dimethyl sulfoxide (DMSO), ethanol (EtOH), stearic acid, wax, ethylene, a glycerol oligomer, and lactide ionic liquid.

Specifically, the polyethylene glycol 400 (PEG400) is a low-molecular-weight polymer that penetrates between cellulose chains induce to swelling and improve the accessibility of the radical initiator. It has high viscosity and excellent thermal stability, and thus is effective in maintaining a mixed state during reaction.

The dimethyl sulfoxide (DMSO) is a polar aprotic organic solvent that may loosen cellulose crystals and improve reactivity by weakening intermolecular hydrogen bonds, and it may induce an efficient plasticization reaction by increasing the mobility and dispersibility of radicals.

The ethanol (EtOH) is a low-molecular-weight alcohol with high volatility, which may contribute to controlling viscosity during the reaction and ensuring thermal stability of the mixture. In addition, it has an advantage in that post-processing is simple as it is easy to remove residual solvent after the reaction.

The stearic acid is a higher fatty acid that may interact with the cellulose surface to induce partial hydrophobicity and increase fluidity. It may act as an interface stabilizer during the radical reaction, thereby increasing reaction efficiency.

The wax is a polymeric solid material that provides fluidity in a high-temperature reaction environment, may contribute to maintaining fine dispersion of cellulose particles, and is particularly effective in ensuring uniformity of reaction under high-viscosity conditions.

The ethylene is a radical polymerizable gas, which may induce crosslinking and structural stabilization by combining with the reactive site in cellulose, and has the advantage of being able to function as a crosslinking regulator that controls reactivity.

The glycerol oligomer is a hydrophilic polymer that breaks hydrogen bonds between cellulose chains and expands the reaction facilitating radical reactions. It also remains stable without deterioration even at high temperatures.

The lactide ionic liquid is a reaction medium having ionicity, low volatility, and excellent solubility, and may relax the crystalline structure of cellulose and promote ion exchange between reactants, thereby increasing the rate of radical transfer.

The reaction media may be applied in the form of a mixture. For example, the PEG400 and the DMSO may be combined at a 1:1 ratio, and the glycerol oligomer and the ionic liquid may be combined at a 1:1 ratio.

More preferably, when PEG400, DMSO, the glycerol oligomer, and the ionic liquid are combined at a ratio of 5:2:2:1, the reaction medium components may act complementarily to each other, thereby exhibiting an excellent effect of improving the swelling, plasticization, reaction stability, and dispersibility of cellulose.

In addition, according to a preferred embodiment of the present disclosure, the reaction composition may further include any one or more auxiliary agents selected from among a silane coupling agent and a nonionic surfactant.

The silane coupling agent is a compound having both an organic group and an inorganic group, which increases interfacial adhesion and chemical stability by reacting with the hydroxyl group (—OH) on the surface of cellulose and contributes to improving dispersibility and preventing aggregation by modifying the surface of nanocellulose particles generated after radical reaction. Preferably, an aminosilane-based compound, epoxysilane-based, or methoxysilane-based compound may be used.

The nonionic surfactant is attached to the surface of cellulose particles through physical adsorption, thus providing electrostatic stabilization and interfacial tension reduction effects, controls the rheological properties of the entire reaction mixture, and is effective in ensuring uniform dispersion and suppressing aggregation of nano-sized particles. Preferably, a polyoxyethylene (POE)-based compound, sorbitan ester (Tween, Span series), etc. may be used.

The silane coupling agent and the nonionic surfactant may be used alone or in combination, and are preferably used in combination. They are preferably included in an amount of 0.1 to 10 parts by weight based on the total weight of the composition. When both the silane coupling agent and the nonionic surfactant are included as auxiliary agents, they may simultaneously impart chemical stability and physical dispersibility to the surface of cellulose, thereby achieving complex functional improvements such as improved reaction stability, suppression of nanoparticle aggregation, and improved compatibility in subsequent applications.

In addition, the cellulose mixture of the present disclosure preferably contains cellulose, the radical initiator, the catalyst, the reaction medium, and the auxiliary agent at a certain ratio, and may contain, based on 100 parts by weight of the total weight of the cellulose mixture, 60 to 85 parts by weight of the cellulose, 0.5 to 5 parts by weight of the radical initiator, 0.1 to 3 parts by weight of the catalyst, 10 to 40 parts by weight of the reaction medium, and 0.1 to 10 parts by weight of the auxiliary agent.

If the content of the cellulose is less than 60 parts by weight, the main component in the entire composition may be insufficient, which may lower the yield of nanocellulose and reduce the efficiency of the dry reaction. On the other hand, if the content is more than 85 parts by weight, the viscosity of the mixture may become excessively high, making it difficult to uniformly distribute the mixture within a mixer, and a problem may arise in that the plasticization and nanofibrillation reactions may proceed non-uniformly due to an imbalance in heat transfer during the reaction.

If the content of the radical initiator is less than 0.5 parts by weight, the reaction initiation will be insufficient, and the molecular chain scission and plasticization reaction of cellulose will not occur sufficiently. If the content is more than 5 parts by weight, excessive radical generation may cause decomposition or abnormal cross-linking of cellulose, resulting in deterioration in the material properties.

If the content of the catalyst is less than 0.1 part by weight, the activation of the initiator will be delayed, significantly slowing down the overall reaction rate, and if the content is more than 3 parts by weight, the stability of the product and the ease of post-processing may be reduced due to unwanted catalyst residue.

If the content of the reaction medium is less than 10 parts by weight, penetration into cellulose and swelling will not be sufficient, and thus the reactivity of the radical initiator will be reduced. If the content is more than 40 parts by weight, the fluidity of the entire composition may become excessively high, making it difficult to control the torque of the reactor, and gas emission and viscosity imbalance may occur during the reaction, which may reduce the nanofibrillation efficiency.

If the content of the auxiliary agent is less than 0.1 parts by weight, the interface stabilization effect will be weak, making it difficult to prevent aggregation between nanocellulose particles, and the reaction stability may also be reduced. Conversely, if the content is more than 10 parts by weight, the excessive auxiliary agent may interfere with the radical reaction or remain in the product, which may cause adverse effects such as deterioration of physical properties and deterioration of dispersibility during subsequent applications.

Overall, if the contents of the components are out of the weight ranges described above, a large amount of unwanted products may be generated due to side reactions. Such side reactions may include, for example, chain scissoring by radicals. The chain scissoring reaction may cleave the cellulose polymer chains, thereby reducing the molecular weight and making the structure of cellulose uncertain, which may result in the generation of unwanted by-products.

Therefore, in the present disclosure, it is preferable to maintain the mixing ratio of the components within the above-described range, which enables uniform plasticization and nanofibrillation to be achieved under production process conditions, and high-quality nanocellulose to be stably produced.

In the present disclosure, the reaction composition including the radical initiator, the catalyst, and the reaction medium may be mixed with cellulose, and the auxiliary agent may be added thereto, followed by uniform mixing using a rotary mixer.

The mixing method may be performed using known techniques, without being limited thereto.

The cellulose mixture may be placed in a mixer and stirred to carry out a plasticization reaction.

In addition, the plasticization reaction may be carried out by heating at a temperature of 50 to 300° C. for 5 to 60 minutes. When the temperature of the plasticization reaction is 50 to 300° C., the reactivity may be the highest, productivity may be improved, the amount of unwanted by-products may be small, and the quality may be excellent.

Preferably, the temperature of the plasticization reaction may be 70 to 250° C. If the temperature of the plasticization reaction is lower than 70° C., the radical generation efficiency may decrease, so that the reaction may not be initiated. If the temperature is higher than 250° C., it becomes difficult to control the physical properties, and solubility and plasticity may be reduced, which may reduce processability. In addition, the radical reaction rate may excessively increase, so that abnormal interactions between polymer chains may occur, which may result in a decrease in the selectivity of the reaction site, and a decrease in quality due to the generation of unwanted by-products. More preferably, the temperature of the plasticization reaction may be 170° C., and the heating time may be 10 minutes.

The stirring speed of the cellulose mixture may be 300 to 600 rpm.

When the stirring speed is within the above range, more uniform mixing is possible. If the stirring speed is less than 300 rpm, phase separation of the cellulose mixture may occur, and if the stirring speed is more than 600 rpm, it may cause excessive fluidization and lead to unnecessary energy consumption.

In addition, the radical reaction may include a process of sonicating the cellulose mixture. The sonication process may have the effect of producing a high-quality cellulose derivative by more uniformly mixing the cellulose mixture, which may undergo phase separation.

The sonication may be performed using a low frequency of 20 to 30 kHz. When mass-producing a cellulose derivative by applying a low frequency within the above range, effective dispersion by high output may be achieved, preventing phase separation and uniformly mixing the cellulose mixture. However, if the sonication is performed at a frequency of less than 20 kHz, the cellulose structure may be damaged due to excessively strong energy, which may result in a decrease in the uniformity of the reaction. If the frequency is more than 30 kHz, physical mixing may not be smooth, which may result in phase separation, a longer reaction time, and decrease in quality and productivity due to a decrease in uniformity.

The nanocellulose of the present disclosure may have weakened hydrogen bonds within cellulose molecules through the plasticization reaction, and increased plasticity, or a nano-sized diameter due to disintegration.

In addition, according to a preferred embodiment of the present disclosure, the method may further include, after the step of plasticizing, a step of extruding the plasticized cellulose mixture through a reactive extruder.

The extrusion step is a process for achieving control of particle size, induction of structural alignment, prevention of agglomeration, and improvement of suitability for subsequent processes through continuous discharge and molding of the plasticized reaction mixture. In particular, the reactive extruder may simultaneously provide thermal and mechanical energy, and thus there are advantages in that physical nanofibrillation of cellulose is additionally carried out, and it is possible to ensure stability of the final material through treatment of residual reactive components.

The screw speed of the reactive extruder is preferably 30 to 150 rpm, the temperature condition is preferably 140 to 190° C., and the residence time is preferably 1 to 5 minutes, without being limited thereto.

The above extrusion conditions may be optimized depending on the composition, viscosity, reactivity, etc. of the plasticized mixture.

As the above extruder, an extruder having a multi-stage screw structure or mixing elements for dispersion may be used. Preferably, a twin-screw extruder may be used to achieve a better effect on cellulose nanofibrillation and uniform dispersion.

The extrusion step may be followed by an additional forming process such as forming a sheet, film, pellet, etc.

The extrusion step of the present disclosure may function as a process of imparting functionality through mechanical shear force and thermal energy control rather than simple discharge, and in particular, it may continuously process the high-viscosity cellulose mixture, thereby improving industrial expandability and commercialization potential.

Existing nanocellulose production techniques include mechanical treatment (high-pressure homogenization, microfluidizer method, grinder method, ball mill crushing method, bead mill crushing method, freeze crushing method, and shaft kneading method), chemical treatment (TEMPO oxidation method, phosphoric acid esterification method, carboxyl methylation method, sulfonation method, oxygen hydrolysis method, and ionic liquid selective dissolution method), biocompatibility (bacteria), etc., and the above-described techniques can exhibit a daily average production of up to about 50 kg. However, as the nanocellulose of the present disclosure, nanocellulose having a diameter of 100 nm or less may be produced at a production rate of 900 to 1,500 kg/day, which is about 20 times more. The plasticized nanocellulose obtained through the radical reaction of the present disclosure may be characterized by excellent productivity in that it has a short reaction time of 1 to 5 hours, does not require additional processes, and thus may be produced at a very fast rate and mass-produced.

In addition, the mechanical treatment method has a disadvantage in that it consumes a lot of energy because it requires repeated physical crushing, and the organic solvent and acid and base reagents used in the chemical treatment method have a problem in that they can cause serious environmental pollution. However, the nanocellulose produced by the method for producing nanocellulose using a radical reaction according to the present disclosure has a characteristic in that it does not cause environmental pollution because it is produced using relatively environmentally friendly reactants and reagents.

Furthermore, the nanocellulose produced by the method for producing nanocellulose using a radical reaction according to the present disclosure exhibits excellent mechanical properties, biodegradability, excellent plasticity, high specific surface area, etc., and thus may be used as a reinforcement for composite materials such as plastics, metals, and ceramics, and as a reinforcement for building materials such as concrete and cement, and may be used in the manufacture of non-woven fabrics, paper, and packaging materials. In addition, it may be used in the medical and life science fields such as drug delivery systems, tissue engineering scaffolds, and wound healing materials, and may be applied to surface coatings and films due to its improved waterproofing, transparency, and durability properties, and may be used as a viscosity regulator and a stabilizer for cosmetics. In addition, it may be applied as an insulating material for conductive composite materials and electronic devices, and may be used in environmental purification technologies such as adsorption and removal of pollutants and wastewater treatment. In addition, it may be used as a viscosity regulator and a stabilizer for foods to improve food texture and quality. However, the application fields of the nanocellulose are not limited thereto.

Hereinafter, the present disclosure will be described in more detail with reference to examples and comparative examples.

However, the following examples and comparative examples are merely examples for explaining the present disclosure in more detail, and the present disclosure is not limited to the following examples and comparative examples.

### EXAMPLES RELATED TO CELLULOSE DERIVATIVES INCLUDING FATTY ACID ESTER BONDED AS SIDE CHAIN

### Example 1

Cellulose with an average diameter of 100 μm was dried in a vacuum oven at 100° C. for 6 hours to completely remove moisture. 30 kg of glycerol monostearate was placed in a reactor, purged with nitrogen, and completely liquefied by heating and stirring at 70° C. and 200 rpm. This was followed by heating at 100° C. 100 kg of the previously dried cellulose was added thereto, and then the rotation speed was increased to 500 rpm, followed by stirring so that the two materials were well mixed. Next, 5 kg of benzoyl peroxide (BPO) as an initiator and 1 kg of tin (II) octoate were added thereto, and a radical reaction was performed at 100° C. for 2 hours. After completion of the reaction, the reaction mixture was cooled to terminate the radical reaction, and the residual reactants and catalyst contained in the resulting cellulose complex were washed out with methanol. Finally, the product was dried to obtain a cellulose derivative.

### Example 2-1

A cellulose derivative was produced in the same manner as in Example 1, except that 5 kg of benzoyl peroxide (BPO) as an initiator and 1 kg of tin (II) octoate were added and a radical reaction was performed at 45° C. for 2 hours.

### Example 2-2

A cellulose derivative was produced in the same manner as in Example 1, except that 5 kg of benzoyl peroxide (BPO) as an initiator and 1 kg of tin (II) octoate were added and a radical reaction was performed at 310° C. for 2 hours.

### Example 3

A cellulose derivative was produced in the same manner as in Example 1, except that 100 kg of dried cellulose was slowly added, and then the rotation speed was increased to 500 rpm, stirring was performed so that the two materials were well mixed, and a sonication process at 25 kHz was further included.

### Comparative Example 1

Cellulose with an average diameter of 100 μm was dried in a vacuum oven at 100° C. for 6 hours to completely remove moisture, and then oxidized using 2,2,6,-tetramethylpiperidine-1-oxyl (TEMPO) as an oxidizing agent, thereby producing a cellulose derivative.

### Comparative Example 2

Cellulose with an average diameter of 100 μm was dried in a vacuum oven at 100° C. for 6 hours to completely remove moisture, and then the cellulose fibers were mixed with a phosphoric acid monoester and subjected to phosphoric acid esterification, thereby producing a cellulose derivative.

### Comparative Example 3

Cellulose with an average diameter of 100 μm was dried in a vacuum oven at 100° C. for 6 hours to completely remove moisture, and then physically crushed using a high-pressure homogenizer, thereby producing a cellulose derivative.

### Comparative Example 4

Cellulose with an average diameter of 100 μm was dried in a vacuum oven at 100° C. for 6 hours to completely remove moisture, and then physically crushed using a ball mill, thereby producing a cellulose derivative.

### <Experimental Example 1> Measurement of Production Amount and Fiber Diameter

The production amount was calculated by weighing the weight of the cellulose derivative with a fiber diameter of 100 nm or less, produced over 24 hours, and the fiber diameter was measured using scanning electron microscopy (SEM). The results are shown in Table 1 below.

TABLE 1

| | | Fiber diameter | Production amount |
|---|---|---|---|
| | | (nm) | (kg/day) |
| Example | 1 | 83 | 1,013 |
| | 2-1 | 92 | 953 |
| | 2-2 | 88 | 982 |
| | 3 | 51 | 1,221 |
| Comparative | 1 | 15 | 55 |
| Example | 2 | 21 | 48 |
| | 3 | 87 | 8 |
| | 4 | 98 | 5 |

Referring to Table 1 above, it could be confirmed that nanofibrillated cellulose derivatives having a fiber diameter of 100 nm or less were formed in all cases of Examples 1 to 3 and Comparative Examples 1 to 4. However, there was a large difference in the production amount between the Examples and the Comparative Examples, and Examples 1 to 3, in which the cellulose derivatives were produced through the radical branching reaction, showed much higher productivity compared to Comparative Examples 1 to 4. In particular, Example 3, which further included the sonication process to promote uniform mixing of the reactants, showed the highest production amount, which was about 200 times higher than that in Comparative Example 4 in which the cellulose derivative was produced through mechanical treatment.

### <Experimental Example 2> Structural Analysis Using Infrared Spectroscopy

Whether functional groups were introduced through the branching reactions of Examples 1 to 3 was analyzed using FT-IR spectroscopy. In the case of microcellulose before the reaction, absorption corresponding to the characteristic stretching vibration of the hydroxyl group appeared at around 3,400 to 3, 600 cm⁻¹, and the stretching vibration absorption of the methyl group appeared at around 2,920 cm⁻¹.

It could be confirmed that, in Examples 1 to 3 including cellulose derivatives produced by the branching reaction, absorption corresponding to the characteristic stretching vibration of a hydroxyl group appeared at around 3,400 to 3,600 cm⁻¹, and additionally, new stretching vibration absorption of a methylene group appeared at around 2,850 cm⁻¹. In addition, it could be confirmed that a peak corresponding to the stretching vibration of a carbonyl group that may be present in the branched cellulose of the present disclosure was observed at around 1,690 cm⁻¹, suggesting that glycerol monostearate was introduced through the branching reaction.

### Examples Related to Method for Producing Dry Nanocellulose Using Radical Reaction

### Examples 1 to 4 and Comparative Examples 1 and 2

In the following Examples and Comparative Examples, a mixture containing dried fine cellulose powder, a radical initiator, a catalyst, and a reaction medium in the amounts shown in Table 2 below was prepared, placed in a rotary high-viscosity mixer (HAAKE Mixer), and mixed at room temperature for 5 minutes. The mixture was placed in a rheometer (HAAKE Torque Rheometer) set to a temperature of 170° C., and stirred at 600 rpm for 10 minutes. The plasticized mixture was continuously extruded using a twin-screw reactive extruder (170° C. and 50 rpm). The extruded filament was cooled at room temperature, and then cut and collected as powder.

TABLE 2

| | Reaction medium and content | Auxiliary agent and |
|---|---|---|
| | (parts by weight) | content (parts by weight) |
| Example 1 | Polyethylene glycol | Aminosilane: 0.5, and |
| | (PEG400): 20, and ionic | Tween 80: 0.5 |
| | liquid: 10 | |
| Example 2 | Dimethyl sulfoxide (DMSO): | (3- |
| | 22.5, and ionic liquid: 7.5 | glycidyloxypropyl)trimethoxysilane |
| | | (GPTMS): 0.5, and |
| | | Span 60: 0.5 |
| Example 3 | Glycerol oligomer: 25 | (3- |
| | | glycidyloxypropyl)trimethoxysilane |
| | | (GPTMS): 0.5, and |
| | | Span 60: 0.5 |
| Example 4 | Polyethylene glycol | Aminosilane: 0.5, and |
| | (PEG400): 20, dimethyl | Tween 80: 0.5 |
| | sulfoxide (DMSO): 8, and | |
| | glycerol oligomer: 4 | |
| Comparative | Not present | Not present |
| Example 1 | | |
| Comparative | Polyethylene glycol | Not present |
| Example 2 | (PEG400): 20, dimethyl | |
| | sulfoxide (DMSO): 8, and | |
| | glycerol oligomer: 4 | |

### Experimental Example: Analysis Methods and Evaluation

The Examples and the Comparative Examples were evaluated using the following analysis method, and the results are shown in Table 3 below.

### (1) FT-IR Analysis

To confirm the change in the chemical structure of the produced cellulose product, FT-IR (Fourier Transform Infrared Spectroscopy) analysis was performed.

For analysis, the sample was purified using the KBr purification method and then measured in the wavelength range of 4,000 to 500 cm⁻¹. The main observation items included changes in —OH, —C═O, —C—O—C—, etc. and changes in bond strength.

### (2) Scanning Electron Microscope (SEM) Analysis

In order to analyze the particle shape and size of the produced nanocellulose, scanning electron microscopy (SEM) analysis was performed. The sample was observed at 5,000× to 30,000× magnification after metal sputtering treatment, and the particle diameter and the dispersion state of the fiber shape were analyzed.

### (3) Measurement of Dispersion

After dispersing the produced nanocellulose in distilled water and ethanol at a certain concentration, the precipitation and dispersion state over time were measured through visual observation and photography, and the change in light transmittance (spectrophotometer, 600 nm wavelength) was measured after 0, 1, 12, 24, 48, and 72 hours, followed by quantitative evaluation.

### (4) Thermogravimetric (TGA) Analysis

In order to evaluate the thermal stability of nanocellulose, TGA analysis was performed using a thermogravimetric analyzer. About 10 mg of the sample was heated from 25° C. to 600° C. at a heating rate of 10° C./min under a nitrogen atmosphere (N₂), and the initial decomposition temperature, maximum decomposition rate temperature, and residual carbon amount were comparatively analyzed. The results are shown in Table 3 below.

TABLE 3

| | Particle | Dispersion | Thermal | Surface | Comprehensive |
|---|---|---|---|---|---|
| | size | stability | stability | modification | evaluation |
| Example 1 | 200 to | 48 hr or | Good | Good | Balanced |
| | 500 nm | more | | | |
| Example 2 | 150 to | 72 hr or | Good | Very good | Highly |
| | 350 nm | more | | | functional |
| Example 3 | 250 to | 12 to | Mid-high | Moderate | Moderate |
| | 600 nm | 24 hr | | | |
| Example 4 | 100 to | 72 hr or | Best | Best | Best |
| | 300 nm | more | | | |
| Comparative | 10 to | 1 to | Low | — | Poor |
| Example 1 | 20 μm | 2 hr | | | |
| Comparative | 300 to | 12 hr | Moderate | Insufficient | Limited |
| Example 2 | 700 nm | | | | |

In Example 1, as a result of treating cellulose using aminosilane and Tween 80 as auxiliary agents in the reaction medium consisting of the combination of PEG400 and the ionic liquid at a ratio of 2:1, uniform nanofibers with an average diameter of 200 to 500 nm were produced, and good physical dispersion stability was maintained for 48 hours or more.

Example 2, in which GPTMS and Span 60 were used as auxiliary agents in the reaction medium consisting of the combination of DMSO and the ionic liquid at a ratio of 3:1, showed an average particle size of 150 to 350 nm, dispersion retention for 72 hours s or more, and excellent surface modification and thermal stability. In particular, chemical modification of the cellulose surface was clearly observed through FT-IR analysis.

In the case of Example 3 in which the reaction medium consisting of the glycerol oligomer alone was used, the particle size was reduced to the level of 250 to 600 nm, and reaction stability was ensured, but the dispersion stability and surface modification effects were somewhat insufficient compared to those of the other Examples.

It was confirmed that, in Example 4 including aminosilane and Tween 80 as auxiliary agents in the reaction medium consisting of the combination of PEG400, DMSO, and the glycerol oligomer at a ratio of 5:2:2:1, the average particle size was 100 to 300 nm, indicating the most precise nanofibrillation, the dispersion stability was 72 hours or more, which is very good, and the thermal stability and the chemical modification effect observed through FT-IR analysis were also the best. Overall, it was proven that the conditions of Example 4 were the most ideal reaction conditions in the present disclosure.

Meanwhile, in Comparative Example 2 in which the same reaction medium combination as in Example 4 was used, but the reaction was carried out under conditions excluding the auxiliary agent, the particle size was 300 to 700 nm, indicating that nanofibrillation progressed to some extent, but aggregation occurred, the dispersion retention time was shortened to about 12 hours, and the structural change observed through FT-IR was also insufficient, suggesting that the absence of the auxiliary agent had a negative effect on the reaction efficiency.

In addition, Comparative Example 1 in which the reaction was performed under conditions excluding both the reaction medium and the auxiliary agent, nanofibrillation hardly progressed (particle size was maintained at the level of 10 to 20 μm), viscosity instability and hardening occurred during the reaction, and significantly poor results in both dispersion stability and thermal stability appeared.

As such, the Examples of the present disclosure demonstrated that the mixing ratio resulting from the optimization of the combination of the reaction medium and the auxiliary agent had a decisive influence on the particle size control, dispersion stability, surface modification, and thermal stability of nanocellulose. Among these Examples, Example 4, in which the combination of PEG400, DMSO, and the glycerol oligomer at a ratio of 5:2:2:1, showed the best results.

Although the preferred embodiments of the present disclosure have been described above, it will be understood by those skilled in the art that various modifications and alterations to the present disclosure are possible departing from the technical spirit of the present disclosure as set forth in the claims below.

What is claimed is:

1. A cellulose derivative with improved productivity, comprising:
cellulose; and
a fatty acid ester bonded as a side chain to the cellulose by a branching reaction,
wherein the branching reaction is performed through a radical reaction using an initiator and a catalyst.

2. The cellulose derivative of claim 1, wherein the branching reaction is performed using, based on 100 parts by weight of the cellulose, 1 to 50 parts by weight of the fatty acid ester, 0.01 to 10 parts by weight of the initiator, and 0.01 to 10 parts by weight of the catalyst.

3. The cellulose derivative of claim 1, wherein the fatty acid ester is glycerol monostearate.

4. The cellulose derivative of claim 1, wherein the initiator comprises any one or more selected from among peroxides and azo compounds.

5. The cellulose derivative of claim 1, wherein the branching reaction is performed at a temperature of 50 to 300° C.

6. The cellulose derivative of claim 1, wherein, in the branching reaction, the fatty acid ester is bonded to oxygen of at least one selected from among C2, C3 and C6 hydroxyl groups of the cellulose instead of hydrogen.

7. A method for producing dry nanocellulose, comprising steps of:
mixing cellulose with a reaction composition comprising a radical initiator, a catalyst, and a reaction medium; and
plasticizing the cellulose mixture by stirring and heating.

8. The method of claim 7, wherein the radical initiator comprises any one or more selected from among organic peroxide-based, hydroperoxide-based, and hydrogen peroxide-based compounds.

9. The method of claim 7, wherein the catalyst comprises any one or more selected from among iron ions (Fe²⁺), cobalt ions (Co²⁺), manganese ions (Mn²⁺), copper ions (Cu⁺), and copper ions (Cu²⁺).

10. The method of claim 7, wherein the reaction medium comprises any one or more selected from among polyethylene glycol 400 (PEG400), dimethyl sulfoxide (DMSO), ethanol (EtOH), stearic acid, wax, ethylene, a glycerol oligomer, and lactide ionic liquid.

11. The method of claim 7, wherein the reaction composition further comprises any one or more auxiliary agents selected from among a silane coupling agent and a nonionic surfactant.

12. The method of claim 7, further comprising, after the step of plasticizing, a step of extruding the plasticized cellulose mixture through a reactive extruder.
